(19) United States
(12) Patent Application Publication
(10) Pub. No.: US 2024/0394809 A1
(43) Pub. Date: Nov. 28, 2024

(54) Energy Usage Control System

(71) Applicants: James G. Morrow, Wauwatosa, WI (US); Cheryl Kramer, Wauwatosa, WI (US)

(72) Inventors: James G. Morrow, Wauwatosa, WI (US); Cheryl Kramer, Wauwatosa, WI (US)

(21) Appl. No.: 18/321,403

(22) Filed: May 22, 2023

(51) Int. Cl. G06Q 50/06

(52) U.S. Cl. CPC G06Q 50/06

(57) ABSTRACT

An improved energy usage control system and method for funding of an organization based upon all forms of energy used by the entities controlled by the organization and, in particular, relates to a system to generate a uniform charge for the energy content of the energy used by the entities.

### BACKGROUND OF THE INVENTION

The present invention relates to an energy usage control system which provides for funding of an organization based upon all forms of energy used by the entities controlled by the organization and, in particular, relates to a system to charge for the energy content of the energy used by the entities.

### SUMMARY OF THE INVENTION

An improved energy usage control system and method for paying for the expenditures of an organization by applying a charge to energy used by entities controlled by the organization. The method includes the steps of storing the total amount of the expenditures of the organization over a period of time in a database, storing the total amount of energy used by the entities controlled by the organization during the period of time in terms of a single measure of energy in a database, and also storing a database of energy values for a plurality of forms of energy. The method also includes the steps of converting the energy values for each form of energy to the measure of energy, generating an energy unit charge for each unit of the measure of energy, and charging the entities selling energy a total energy charge equivalent to the total energy sold by the sellers multiplied by the energy unit charge.

### BRIEF DESCRIPTION OF THE DRAWING

This application will become more fully understood from the following detailed description, taken in conjunction with the accompanying FIGURE, wherein like reference numerals refer to like elements in which:

FIG. 1 is a block diagram of the system for utilizing the method disclosed herein.

### DETAILED DESCRIPTION

Various embodiments of the energy usage system include innovative steps for allocating the cost of energy usage by entities controlled by an organization to pay from the expenditures of the organization.

The preferred embodiment of the present invention provides for a federal tax system which taxes the units of energy used in this country and eliminates all other federal taxes of any type (e.g. estate, social security, Medicare, Medicaid, income, use, etc.) placed on the governments citizens. The unit which this method proposes using is the British Thermal Unit (BTU). In 2021, the federal government (e.g. an organization) spent a total of $6.8 trillion dollars, and the US used a total of 97.331 quadrillion BTU of energy. Accordingly, to fully pay for the 2021 federal spending, each BTU used in the US would be taxed at a rate of $0.00007 per BTU i.e. an energy use tax, hereinafter referred to as the EUT. (The numbers used herein are taken from various public sources believed to be relatively accurate but may not be exact and are for exemplary use.)

This goal of the EUT is to provide a simple, revenue-predictable, efficient and relatively policy-free taxation system. The EUT is based, in part, upon the search for a tax which is related/proportional to resource use and the idea that government policy should be implemented purely with spending-based decisions and not a tax system. Theoretically, the primary purposes of our government are to defend its citizens, protect property rights and provides these citizens with a reasonable infrastructure (structural and legal) which facilitates and improves day-to-day business and personal activity. Unfortunately, to accomplish these purposes taxes must be collected. However, attempting policy implementation with a tax collection system is highly inefficient because it is too complex for any group of humans to intellectually handle when done in combination with spending-based policy implementation. By way of a crude analogy, driving a car with one competent person steering is manageable; driving a car while 2 people (especially if incompetent) are steering without the other understanding or knowing where the other is going or doing would, more often than not, result in an accident with people getting injured if not killed.

The current US tax system is infinitely complex as a result of the using taxation and spending for parallel, loosely coordinated policy implementation. As clear evidence of this complexity, the United States Tax Code (Title 26 of the U.S. Code) is over 1,000,000 words long, the US regulations which implement this Code are about 4,000,000 words long, the words of IRS letter opinions are immeasurable, and finally there are thousands of court and agency decisions interpreting the statutory and regulatory tax law. (These are estimated numbers.)

The system proposed in this patent application is an energy-based tax system. At first glance, this type of tax system may appear to be based upon energy policy. However, the proposed tax system is based upon energy use because every product or service in our economy requires energy. This proposed tax would be the sole source of federal government revenue and would eliminate all other taxes (e.g. Medicare, Medicaid, social security, etc.) and fees required by the government to permit an activity regulated by the government (license fees, use fees, tolls, etc.). In the 21st century the most basic measure for the resources a person or organization extracts from the US economy is energy use. For example, a person maintaining basic housing, transportation and nutrition does not, on a relative basis, consume much energy. However, a person or business heating and cooling numerous buildings, driving a range of vehicles, routinely using aircraft, and purchasing numerous products and services, consumes substantial amounts of energy. This consumption is highly related to the resources extracted from the US economy. In the 21st century everything any person or business (e.g. entities controlled by the US Government) uses whether it is a product or service requires energy.

With the implementation of the system described herein, the federal government could stop being concerned about vehicle efficiency, use of electric cars, appliance efficiency, energy waste, solar cell usage, wind turbine usage, etc. The markets would swiftly and effectively eliminate energy inefficiency though conservation and the use of the most cost-effective energy sources.

Many commentators and politicians have discussed and considered use, sales and/or value added tax systems. In the US, we already have a patchwork of government fees, and sales and use taxes (e.g. gas tax, telephone taxes, utility use taxes, etc.) added at both the state and federal levels. These are merely additional taxes the government is able extract in addition to the complicated, policy-laden income tax. However, in evaluating sales and use tax systems it is difficult to develop a basis for taxation other than a dollar value of a particular product or service. As the dollar values fluctuate due to changes in supply and demand, the tax revenue amount and tax calculation change. The goal of the present system and method is to provide a more stable basis for applying a sales/use tax which is fair, simple to apply, efficient to implement and free of tax filings and the associated accounting for the vast majority of persons and businesses in the US.

In our current economy, an efficient income tax system is not possible. Actually, it has never worked in an efficient or fair manner. If it had not been for a minority group of prohibitionists seeking to implement 18th amendment (prohibition), the US may not have made the mistake of the 16th amendment (income tax).

Some may argue, for argument's sake, “why not”: a water tax, a bread tax, a liquor tax, a steel tax, a plastic tax, a legal service tax, etc.? Every person and business either directly or indirectly uses all of these products and services. Why not a tax applying to them all? Because energy is the common denominator to the supply of all products and services. Without energy you cannot supply anything to anyone, not water, not bread, not liquor, not steel, not software, not video games, not television, not plastic, not legal services, etc. Without the energy required to deliver a cup of water and piece of bread you cannot even supply a human thought. With an energy unit tax (EUT) there is not a need to endeavor into the complications of applying either specific or general sales/use taxes, and it is not necessary to debate different tax rates. Additionally, an EUT only needs to be accounted for and collected by a few entities (which supply energy to the end user e.g. coal suppliers, oil suppliers, gas suppliers, fuel stations, utilities, etc.) which already account for and collect some form of energy tax.

It is important to the implementation of the proposed EUT that all other taxes, user fees and licenses are ELIMINATED. Absolutely all government spending would be funded with the EUT. The system would include no EUT tax exceptions. All policy considerations would be dealt with on the spending side of government. Some of this spending might change the fairness of the energy tax, but the “2-steering” wheel problem would be eliminated with respect to the EUT.

A common measure of energy for which we have reliable and ongoing data should be the basis for the EUT (referred to as the Unit, Federal Tax in the right-most column below). Units considered were the British Thermal Unit (BTU), newton-meters, foot-pounds, and kilowatt hours (KWH). The BTU basis provides a well understood and convenient energy unit to which the energy content of for all sources of energy can be efficiently converted. BTU is also an energy usage unit which should be familiar to any person who receives a utility bill. The following table provides the BTU measurement for many of the major energy sources currently used.

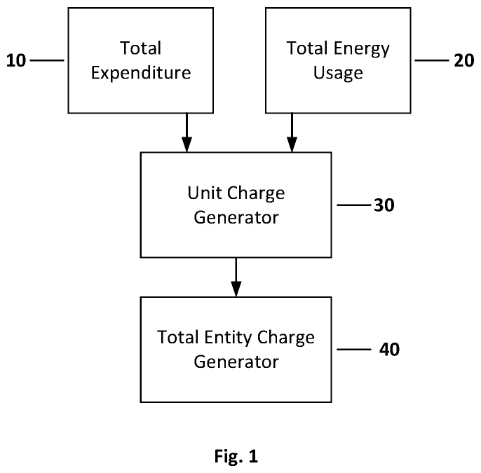

Referring to FIG. 1, the EUT tax for a given year is the total amount spent by the federal government in a given year (total expenditure 10) divided by the total amount of energy used in the US for that year (total energy usage 20). Referring to FIG. 1, the unit charge generator 30 divides expenditure 10 by usage 20 to generate the ETU value. The total entity charge generator 40 multiplies the total energy sold by an energy supplier by the ETU.

The right-most column of the table provides the associated EUTs for a range of forms of energy. For example, with the 2021 level of government spending and total energy use referenced above, the gas tax would be $8.68/gallon of gas.

| | | | | Unit, |
|---|---|---|---|---|
| | | | Energy | Federal |
| | | | Content | Tax ($) at |
| Energy | | | per Unit | $.00007/ |
| Form/ | | | in terms | BTU |
| Source | Unit | | of BTUs | (ETU) |
| Electricity | 1 | Kilowatt-hour | 3412 | $0.24 |
| Butane | 1 | Cubic Foot (cu. ft.) | 3200 | $0.22 |
| Coal | 1 | Ton | 28000000 | $1,960.00 |
| Crude Oil | 1 Barrel - 42 gallons | | 5800000 | $406.00 |
| Fuel Oil no. 1 | 1 | Gallon | 137400 | $9.62 |
| Fuel Oil no. 2 | 1 | Gallon | 139600 | $9.77 |
| Fuel Oil no. 3 | 1 | Gallon | 141800 | $9.93 |
| Fuel Oil no. 4 | 1 | Gallon | 145100 | $10.16 |
| Fuel Oil no. 5 | 1 | Gallon | 148800 | $10.42 |
| Fuel Oil no. 6 | 1 | Gallon | 152400 | $10.67 |
| Diesel Fuel | 1 | Gallon | 139000 | $9.73 |
| Gasoline | 1 | Gallon | 124000 | $8.68 |
| Natural Gas | 1 | Cubic Foot (cu. ft.) | 1050 | $0.07 |
| Heating Oil | 1 | Gallon | 139000 | $9.73 |
| Kerosene | 1 | Gallon | 135000 | $9.45 |
| Pellets | 1 | Ton | 16500000 | $1,155.00 |
| Propane LPG | 1 | Gallon | 91330 | $6.39 |
| (Liquid | | | | |
| Petroleum Gas) | | | | |
| Propane gas | 1 | Cubic Foot (cu. ft.) | 2550 | $0.18 |
| 60° F. | | | | |
| Residual Fuel | 1 Barrel - 42 gallons | | 6287000 | $440.09 |
| Oil 1) | | | | |
| Wood - air dried | 1 | Cord | 20000000 | $1,400.00 |
| Wood - air dried | 1 | pound | 8000 | $0.56 |

The energy tax would not have offsets when one energy source is used to generate another energy source. For example, if natural gas were used to generate electricity, the energy tax would first be applied to the natural gas and then again to electricity. Yes, a double tax. An effect of this would be to have energy used for its primary/best purpose wherever possible. Only the mentally challenged would convert natural gas at a power plant to electricity and then transmit it to the end user for electric heat, cooking or to charge an electric car. Even a highly efficient power plant and transmission system can only transmit about 30% of the energy from the natural gas in the form of useable electricity to the end user.

So, who can afford a gas tax of $8.68/gallon, an electricity tax of $0.24 per kwh and a natural gas tax of $0.07/ft3 for natural gas? The middle class . . . really! In the US, a couple in the middle of the middle class makes about $90,000 per year. Under the EUT, they would take home $90,000 per year. Neither the worker nor the employer would pay social security, Medicare, Medicaid, federal income tax or any other taxes or fees.

Assuming the couple drives the typical 30,000 miles per year (average in the US for 2 people) in vehicles which get the 2026 federal mileage requirement of 40 mpg, their yearly gas tax would be $3255. Assuming the couple lives in an average home in the US, the yearly electricity tax would be $2552 and the yearly natural gas tax would be $5008. This is a total direct EUT tax on the couple of $10,815. Under the current federal tax, the social security tax and Medicare tax would have been $6885 and the federal income tax would have been $9720, for a total of $16,605. This is roughly a 60% tax reduction for the average couple.

Of course, the argument will be that this couple will be paying more for goods and services because of the EUT pass-through from the respective business. However, businesses would no longer incur the accounting and legal fees associated with the current federal tax system, and they would no longer need to pay the other half of social security, Medicare and Medicaid taxes. The need to account for purposes of tax filings is eliminated for all but the energy suppliers. However, essentially all of the energy suppliers already have a system in place to pay energy taxes. Gas stations account for federal and state gas taxes, utilities account for federal and state electricity and natural gas taxes, etc. Only the amount of the energy tax would change. To summarize, the savings for businesses as a result of not having to deal with the current federal taxation system would offset a substantial portion of the EUT by which they would be affected.

In addition, the EUT tax may go down when the federal government gives up dealing with the income tax system and providing handouts to every person and entity with a new energy idea.

To implement the system the current tax code would be replaced with the following:
1. All sellers of energy shall pay a tax equivalent to the total energy value of the energy sold by such seller to the End User of such energy multiplied a BTU tax in the amount of $0.00007 per BTU (“EUT Tax”). Congress may from time to time update the BTU tax prior to a calendar year. An update in a calendar year by Congress shall apply to the subsequent calendar year.
2. The End User of energy is defined as a user which converts the energy from one type to another e.g., the burning of natural gas for heat or electricity generation, the commercial or residential use of electrical energy, etc.
3. All importers of products to the US shall pay a tax equivalent to the energy used to manufacture and ship such products to the US multiplied by the BTU tax set out in section 1 above.
4. Sellers and importers shall pay the EUT tax on a calendar, quarterly basis and make such payment within 45 days of the end of a respective calendar quarter.

The IRS staff and systems would be reduced to a size appropriate to collect and properly audit sellers of energy and importers of goods. Instead of having over 250 million taxpayers, the IRS would have only limited number of energy taxpayers and importers.

There will be intended, and unintended consequences associated with the adoption of an EUT. However, reasonable minds should agree that this type of tax system would greatly simplify the lives of the average citizen. We should also be able to agree that the average citizen would now have the ability to better control their taxes by managing their energy use. The typical person may seriously consider a more energy efficient car, home, appliances, etc., but this would be up to them.

To the extent that the EUT is regressive, the federal government can, as they always do, hand out money in an attempt to be “fair.” However, this must NOT be part of the EUT it must be done though a separate system such as the welfare system.

Even though the EUT would be an advance for the average citizen and the economy, it is unlikely to happen. As should be apparent to all readers, the pressure from tax system dependent special interests would be unbearable. Additionally, a major consequence would be a substantial transient unemployment by those who make a living on the current federal tax code, IRS employees included. These are not typically the average citizens and are not the people who actually make something useful for others to use. The only reason their services are useful is because the federal government chooses to have a complicated, unfair, massive, policy laden, onerous tax system.

The inventors dearly love and cherish their 3 children and grandchildren and hope that they have productive and happy lives. The inventors have filed this patent application in the hopes that the disclosed system will be seriously considered by our leaders for use as a tax system before the tax system we currently have causes our great country to fail and rob our children of a productive and bright future.

It should be understood that the FIGURE illustrates the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the invention will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes, and omissions may also be made in the design, operating conditions, and arrangement of the various exemplary embodiments without departing from the scope of the present invention.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element and is not intended to be construed as meaning only one.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

What is claimed is:

1. A method for paying for the expenditures of an organization by applying a charge to energy used by entities controlled by the organization, the method comprising:
storing the total amount of the expenditures over a period of time;
storing the total amount of energy used by the entities controlled by the organization during the period of time in terms of a single measure of energy;
generating an energy unit charge equivalent to the total amount of expenditures divided by the total amount of energy used;
charging the entities selling energy a total energy charge equivalent to the total energy sold by the sellers multiplied by the energy unit charge.

2. The method of claim 1, wherein the organization is a government.

3. The method of claim 2, wherein the total expenditures are equivalent to the budget of the government for a first year.

4. The method of claim 3, wherein the entities are all citizens and businesses under the jurisdiction of the government.

5. The method of claim 4, wherein energy unit charge is a charge per British Thermal Unit (“BTU”).
